(19) United States
(12) Patent Application Publication
(10) Pub. No.: US 2004/0057089 A1
(43) Pub. Date: Mar. 25, 2004

(54) System and method for detecting differences between complex images

(76) Inventor: Edgar Voelkl, Austin, TX (US)

Correspondence Address: BAKER BOTTS L.L.P., PATENT DEPARTMENT, 98 SAN JACINTO BLVD., SUITE 1500, AUSTIN, TX, 78701-4039, US

(21) Appl. No.: 10/661,873

(22) Filed: Sep. 12, 2003

Related U.S. Application Data
(60) Provisional application No. 60/410,154, filed on Sep. 12, 2002.
(60) Provisional application No. 60/410,156, filed on Sep. 12, 2002.

(51) Int. Cl. G03H 1/00

(52) U.S. Cl. 359/1

(57) ABSTRACT

A system and method for detecting differences between complex images are disclosed. The method includes acquiring a first complex image and a second complex image and determining if an aberration value difference exists between the first and second complex images. The aberration value difference is corrected by iteratively modifying the first complex image by an aberration function and comparing the modified first complex image with the second complex image in a high frequency range. The method further determines if the modified first complex image matches the second complex image by modifying the second complex image with a low frequency ratio to replace low frequency components of the second complex image with low frequency components of the first complex image. The high frequency components of the modified first complex image and the modified second complex images are then compared to determine if the first complex image matches the second complex image.

### CROSS REFERENCE TO RELATED APPLICATION

This application claims priority from U.S. Provisional Patent Application Serial No. 60/410,154, filed Sep. 12, 2002 by Edgar Voelkl, and entitled “Focus/Aberration Correction in a Digital Holographic System,” and U.S. Provisional Patent Application Serial No. 60/410,156, filed Sep. 12, 2002 by Edgar Voelkl, and entitled “Wave Front Matching.”

### TECHNICAL FIELD OF THE INVENTION

This invention relates in general to the field of image processing and, more particularly, to a system and method for detecting differences between complex images.

### BACKGROUND OF THE INVENTION

In a direct-to-digital holography system, holograms from highly similar objects can be obtained. Consecutive processing of the holograms allows comparison of actual image waves of the objects. These image waves contain significantly more information for both small and large details of the objects than conventional non-holographic images, because image phase information is retained in the holograms, but lost in conventional images.

To find small differences in highly similar objects, it is important that the holography system remains in a stable state. Small changes, however, may occur within the system during the time between acquisition of the holograms associated with the highly similar objects. Other changes may occur because the object may not be positioned exactly the same way at different locations, e.g., the objects may be at a different focus at different locations. Both of the system specific and the location dependent changes can cause artifacts (e.g., artificial or virtual differences) to occur when determining if differences exist between these objects. If no system specific and/or location dependent changes occurred, the measured differences would unambiguously determine the actual difference between the objects.

In some applications, such as defect inspection for a semiconductor wafer, the holography system may be used to acquire multiple images from different locations on objects that were meant to be identical. Although the objects at different locations may be highly similar, the aberration values, e.g., focus, at each location may differ and thus the images from different locations may appear to be different. In conventional image acquisition systems, an image from one location on the object may be obtained. The system then moves to another location on the object that includes an image having approximately the same features. The system obtains an image at the second location and determines the difference in focus values between the first and second images. If the focus values between the two images differ, the system adjusts the focus values associated with the second image to approximately match the focus values associated with the first image and re-acquires the second image with the adjusted focus values. This process more than doubles the time required to obtain the image from the second location and can increase the cost associated with obtaining multiple images from one object.

Holographic images differ from real images because holographic images contain intensity and phase information while real images only contain intensity information. The additional phase information in holographic imaging adds a new dimension of complexity, as well as new possibilities beyond standard image processing tools and capabilities. For example, wave front matching capabilities would have little merit for intensity images (e.g., real images), whereas they are important for image waves (e.g., complex images), as they address the phase in the image wave that does not exist in the intensity image.

Complex images, like real images, include high frequency portions and low frequency portions. Typically, actual differences in the images will occur in the high frequency components of the images. Any location dependent or system specific changes, however, may cause artificial or virtual differences in both the high frequency and low frequency components of the images. In some complex images, the low frequency portions of two different images may be different due to the small system specific changes, such as minor air turbulences. The low frequency differences may create artificial differences between the images such that the system cannot accurately determine the actual high frequency differences between the images.

In standard image processing, a Fourier filter may be applied to both images and a low pass filter may be used to obtain the low frequency portion of both images. An inverse Fourier filter may then be used to convert the images back to the time domain such that the two images can be compared. This solution, however, does not eliminate the low frequency portions of complex images due to the additional phase information contained in the image waves.

### SUMMARY OF THE INVENTION

In accordance with the teachings of the present invention, disadvantages and problems associated with detecting differences between images have been substantially reduced or eliminated. In a particular embodiment, a method for detecting differences between complex images includes correcting an aberration value difference by modifying a first complex image by an aberration function and comparing the modified image to a second complex image, thus, minimizing the difference between the complex images in the high frequency range.

In accordance with one embodiment of the present invention, a method for detecting differences between images includes acquiring a first complex image and a second complex image and applying a low pass filter to a ratio of the first and second complex images to obtain a low frequency ratio. The second complex image is modified by the low frequency ratio to replace low frequency components of the second complex image with low frequency components of the first complex image. The modified complex image is then compared to the first complex image to determine if the second complex image matches the first complex image.

In accordance with another embodiment of the present invention, a system for detecting differences between images includes a digital recorder for acquiring a first complex image and a second complex image and processing resources coupled to the digital recorder. The processing resources apply a low pass filter to a ratio of the first and second complex images to obtain a low frequency ratio. The second complex image is modified by the low frequency ratio to replace low frequency components of the second complex image with low frequency components of the first complex image. The modified complex image is compared to the first complex image to determine if the second complex image matches the first complex image.

In accordance with a further embodiment of the present invention, a method for detecting differences between complex images includes acquiring a first complex image and a second complex image that have similar features and selecting a plurality of aberration values for the first complex image from an anticipated aberration range. An aberration function is computed for each of the aberration values and the first complex image is iteratively modified by each of the aberration functions. The modified complex image is compared with the second complex image and an aberration correction value is determined by selecting the aberration value that yields the smallest difference between the modified complex image and the second complex image.

In accordance with an additional embodiment of the present invention, a system for detecting differences between complex images includes a digital recorder for acquiring a first complex image and a second complex image having similar features and processing resources coupled to the digital recorder. The processing resources select a plurality of aberration values for the first complex image from an anticipated aberration range and compute an aberration function for each of the aberration values. The first complex image is iteratively modified by each of the aberration functions and the modified complex image is compared with the second complex image. The processing resources determine an aberration correction value by selecting the aberration value that yields the smallest difference between the modified complex image and the second complex image.

In accordance with another embodiment of the present invention, a method for detecting differences between complex images includes acquiring a first complex image and a second complex image having similar features and determining if an aberration value difference exists between the first and second complex images. The aberration value difference is corrected by iteratively modifying the first complex image by an aberration function and comparing the modified first complex image with the second complex image in a high frequency range. The method further determines if the modified first complex image matches the second complex image by modifying the second complex image with a low frequency ratio to replace low frequency components of the second complex image with low frequency components of the first complex image. The high frequency components of the modified first complex image and the modified second complex images are then compared to determine if the first complex image matches the second complex image.

Important technical advantages of certain embodiments of the present invention include a digital-to-direct system that reduces the amount of time needed to acquire multiple images from an object. In some applications, the system may be used to acquire images from different locations on the object. Aberration values associated with each of the acquired images may be different. Instead of re-acquiring an image with adjusted aberration values, the system adjusts a first image with the aberration values associated with a second image.

Another important technical advantage of certain embodiments of the present invention includes a direct-to-digital holography system that eliminates artifacts from an acquired image. Small changes in the system may occur between a time when a first image is acquired and a second image is acquired. These small changes typically occur in low frequency components of the acquired images. The system applies a low frequency filter to a ratio of two acquired images and multiplies one of the images by the ratio to eliminate the low frequency components from the image comparison. Thus, only the high frequency components of the images are compared, which allows the system to accurately determine if any actual differences exist between the two images.

All, some, or none of these technical advantages may be present in various embodiments of the present invention. Other technical advantages will be readily apparent to one skilled in the art from the following figures, descriptions, and claims.

### BRIEF DESCRIPTION OF THE DRAWINGS

A more complete understanding of the present invention and advantages thereof may be acquired by referring to the following description taken in conjunction with the accompanying drawings, in which like reference numbers indicate like features, and wherein:

FIG. 1 illustrates a schematic view of a direct-to-digital holography system in accordance with teachings of the present invention;

FIG. 2 illustrates a schematic view of another direct-to-digital holography system in accordance with teachings of the present invention;

FIG. 3 illustrates two complex images obtained by a direct-to-digital holography system and the resulting image after determining and applying an aberration correction value in accordance with the teachings of the present invention;

FIG. 4 illustrates a complex image obtained by a direct-to-digital holography system without compensation for artifacts caused by changes in the holography system;

FIG. 5 illustrates the complex image of FIG. 4 after eliminating the artifacts in accordance with the teachings of the present invention; and

FIG. 6 illustrates a flow chart of a method for detecting differences between complex images in accordance with teachings of the present invention.

### DETAILED DESCRIPTION

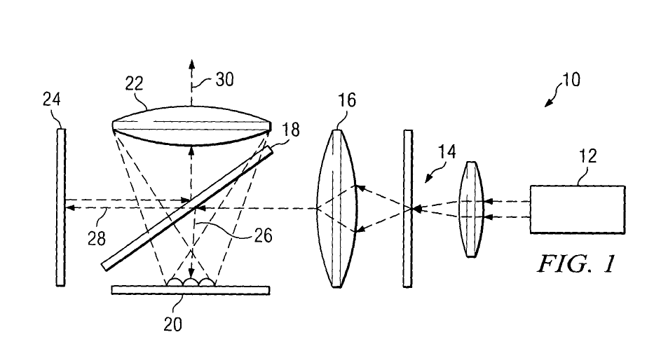

Preferred embodiments of the present invention and their advantages are best understood by reference to FIGS. 1 through 6, where like numbers are used to indicate like and corresponding parts.

The following invention generally relates to digital holographic imaging systems and applications as described in U.S. Pat. No. 6,078,392 entitled Direct-to-Digital Holography and Holovision, U.S. Pat. No. 6,525,821 entitled, Acquisition and Replay Systems for Direct to Digital Holography and Holovision, U.S. patent application Ser. No. 09/949,266 entitled System and Method for Correlated Noise Removal in Complex Imaging Systems, now U.S. Pat. No. ______ and U.S. patent application Ser. No. 09/949,423 entitled, System and Method for Registering Complex Images, now U.S. Pat. No. ______, all of which are incorporated herein by reference.

FIG. 1 illustrates a schematic view of direct-to-digital holography system 10. System 10 includes laser 12, beam expander/spatial filter 14, lens 16, beamsplitter 18, target 20, focusing lens 22 and mirror 24. In the illustrated embodiment, laser 12 directs a beam of light toward expander/filter 14 and the expanded/filtered light travels through lens 16 to beamsplitter 18. Beamsplitter 18 may be any optical element that allows a portion of the beam to be transmitted and a portion of the beam to be reflected. In one embodiment, beamsplitter 18 may be a 50/50 beamsplitter where approximately fifty percent (50%) of a beam is reflected and approximately fifty percent (50%) of the beam is transmitted. In other embodiments, beamsplitter 18 may reflect and/or transmit any suitable percentage of light. Beamsplitter 18 may include, but is not limited to, a cube beamsplitter and a plate beamsplitter.

The expanded/filtered light that is reflected by the beamsplitter constitutes target beam 26 which travels toward target 20. In one embodiment, target 20 may be an electronic device fabricated from silicon, germanium or any compound containing group III and/or group V elements. In another embodiment, target 20 may be a photomask or reticle that includes a pattern formed on a substrate. In other embodiments, target 20 may be any other object, assembly or component from which a complex image may be generated. A portion of the light reflected from target 20 then passes through beamsplitter 18 and travels toward focusing lens 22. Focusing lens 22 may operate to focus target 20 into the focal plane of a digital recorder (not expressly shown). Focusing lens 22 may further provide magnification or demagnification, as desired, by using lenses of different focal length and adjusting the corresponding spatial geometry (e.g., ratio of object distance to image distance). The focused light then travels to the digital recorder. In one embodiment, the digital recorder may be a high resolution charge coupled device (CCD) camera that may record and playback a hologram acquired from target 20. The digital recorder may further be interfaced with a computer (not expressly shown) that includes processing resources. In one embodiment, the processing resources may be one or a combination of a microprocessor, a microcontroller, a digital signal processor (DSP) or any other digital circuitry configured to process information.

The portion of the light from lens 16 that is transmitted through beamsplitter 18 constitutes reference beam 28. Reference beam 28 is reflected from reference mirror 24 at a small angle. The reflected reference beam from reference mirror 24 then travels toward beamsplitter 18. The portion of the reflected reference beam that is reflected by beamsplitter 18 then travels toward focusing lens 22. The reference beam from focusing lens 22 then travels toward the digital recorder. Together, the object beam and reference beam from focusing lens 22 constitute a plurality of simultaneous reference and object waves 30 that form a hologram.

System 10 may use a “Michelson” geometry (e.g., the geometrical relationship of beamsplitter 18, reference beam mirror 24, and the digital recorder resembles a Michelson interferometer geometry). This geometry allows the reference beam and the object beam at focusing lens 22 to be combined at a very small angle. For example, reference mirror 24 may be tilted to create the small angle that makes the spatially heterodyne or sideband fringes for Fourier analysis of the hologram.

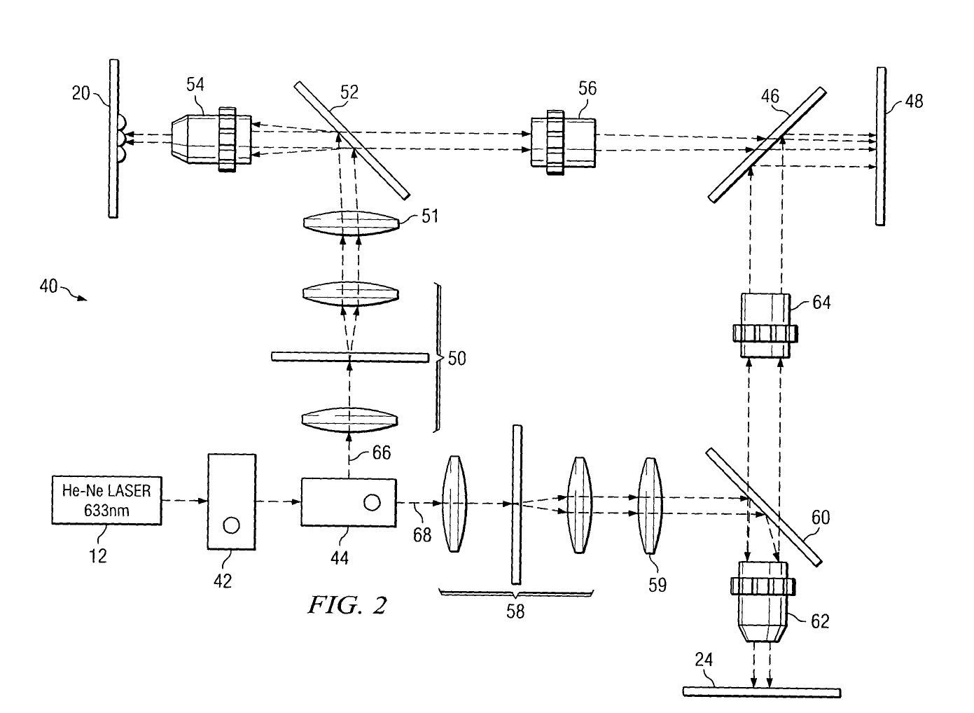

FIG. 2 illustrates a schematic view of another example embodiment of direct-to-digital holography system 40. System 40 includes laser 12, variable attenuator 42, variable beamsplitter 44, a target arm, a reference arm, beam combiner 54 and digital recorder 56. The target arm may include target beam expander 46, target beamsplitter 48, target objective 50, target 20 and target tube lens 52. The reference arm may include reference beam expander 58, reference beamsplitter 60, reference objective 62, reference mirror 24 and reference tube lens 64. In the illustrated embodiment, laser 12 directs a beam of light toward variable attenuator 42 and the attenuated light travels to variable beamsplitter 44. Variable beamsplitter 44 may be an optical element that transmits a portion of the beam and reflects another portion of the beam. In the illustrated embodiment, variable beamsplitter 44 splits the beam of light into target beam 66 and reference beam 68.

Still referring to FIG. 2, target beam 66 is directed through target beam expander 46 toward target beamsplitter 48, which reflects a portion of target beam 66 toward target objective 50. The reflected target beam then interacts with target 20 and passes back through target objective 50. Target beamsplitter 48 transmits the portion of the reflected target beam received from target objective 50 to beam combiner 54 via target tube lens 52. In the reference arm, reference beam 68 from variable beamsplitter 44 passes through reference beam expander 58 and is reflected by reference beamsplitter 60. The reflected portion of reference beam 68 passes through reference objective 62 and is reflected by reference mirror 24. The reflected reference beam then passes back through reference objective 62 and is transmitted by reference beamsplitter 60. Reference tube lens 64 directs the beam toward beam combiner 54, which combines light from the target arm and the reference arm and directs the combined beams to digital recorder 56. In one embodiment, the combined beams may be digital data that be recorded, transmitted and/or transformed.

System 40 may use a Mach-Zender geometry. Comparing the Mach-Zender geometry of FIG. 2 (called Mach-Zender because of its similarity to the geometry of a Mach-Zender interferometer) with the Michelson geometry (as illustrated in FIG. 1), it can be appreciated that the focusing lens (e.g., target objective 50 in FIG. 2) can be much closer to target 20 because through-the-lens illumination allows target beamsplitter 48 to be behind target objective 50 rather than between target objective 50 and target 20. This allows large numerical aperture, high magnification objectives to be used to look at (and record holograms of) small objects. For large objects the original Michelson geometry as illustrated in FIG. 1 may be preferable, depending on the situation.

It can also be appreciated from FIG. 2 that beam combiner 54 may be located close to digital recorder 56. Beam combiner 54 may combine reference beam 66 and object beam 68 to illuminate digital recorder 56. The angle of beam combiner 54 may be varied so that the reference and object beams are exactly co-linear, or in general strike digital recorder 56 at an angle to one another so that the heterodyne carrier fringes are produced. This allows the carrier fringe frequency to be varied from zero to the Nyquist limit of digital recorder 56. Beam combiner 54 may be closer to digital recorder 56 than with the Michelson geometry, at least for magnifying geometries (e.g., geometries where the object hologram is being magnified for acquisition by the digital camera). This allows the combining angle between the object and reference beams to be relatively large without causing the spots from the reference and object beams to no longer overlap at digital recorder 56. This allows much finer control over the carrier frequency fringes. In fact, it may be possible to vary the angle between the two beams from zero up to the maximum angle allowed by the constraints of the system without the spatial carrier frequency of the heterodyne hologram exceeding the Nyquist frequency allowed by the digital recorder (e.g., the angle can be increased until there are only two pixels per fringe of the spatial carrier frequency—beyond this angle the spatial carrier frequency is no longer correctly recorded by the digital recorder). With the Michelson geometry, the maximum spatial carrier frequency of the hologram may not be reachable because the angle required may be large enough that the reference and object beams would no longer overlap at the digital recorder for some geometries.

In operation, systems 10 and 40 may be suitable for recording and replaying holographic images in real time or storing them for replay later. A series of digitally stored holograms may be made to create a holographic motion picture or the holograms can be broadcast electronically for replay at a remote site to provide holographic television (HoloVision). Since a hologram stores amplitude and phase, with phase being directly proportional to wavelength and optical path length, direct-to-digital holography systems 10 and 40 may also serve as extremely precise measurement tools for verifying shapes and dimensions of precision components, assemblies, etc. Similarly, the ability to store the holograms digitally immediately provides a method for digital holographic interferometry. Holograms of the same object, after some physical change (stress, temperature, micromachining, etc.), may be subtracted from one another (direct subtraction of phase) to calculate a physical measurement of the change, where the phase change is directly proportional to wavelength. Similarly one object can be compared to a like object to measure the deviations of the second object from the first or master object, by subtracting the respective holograms. To unambiguously measure phase changes greater than 2π in the z-plane over two pixels in the x-y plane, holograms should be recorded at more than one wavelength.

Systems 10 and 40 combine the use of high resolution digital recorders, such as video cameras, very small angle mixing of the holographic object and reference waves (e.g., mixing at an angle that results in at least two pixels per fringe and at least two fringes per spatial feature to be resolved), imaging of the object at the recording (camera) plane, and Fourier transform analysis of the spatially low-frequency heterodyne (side-band) hologram to make it possible to record holographic images (e.g., images with both the phase and amplitude recorded for every pixel). Additionally, an aperture stop may be used in the back focal plane of one or more lenses involved in focusing the object to prevent aliasing of any frequencies higher than can be resolved by the imaging system. No aperture is necessary if all spatial frequencies in the object are resolvable by the imaging system.

Once recorded, it is possible to either replay the holographic images as 3-D phase or amplitude plots on a two-dimensional display or to replay the complete original recorded wave using a phase change crystal and white light or laser light to replay the original image. The original image is replayed by writing it in the phase-change medium with lasers, and either white light or another laser is used to replay it. By recording an image with three different colors of laser and combining the replayed images, it is possible to make a true-color hologram. By continuously writing and replaying a series of images, it is possible to form holographic motion pictures. Since these images are digitally recorded, they can also be broadcast with radio frequency (RF) waves (e.g., microwave) or over a digital network of fibers or cables using suitable digital encoding technology, and replayed at a remote site. This effectively allows holographic television and motion pictures or “HoloVision.”

Systems 10 and 40 may also be embodied in a number of alternative approaches. For instance, systems 10 and 40 may use phase shifting rather than heterodyne acquisition of the hologram phase and amplitude for each pixel. In another embodiment, systems 10 and 40 may use numerous different methods of writing the intensity pattern to an optically sensitive crystal. These include using a sharply focused scanning laser beam (rather than using a spatial light modulator), writing with an SLM but without the biasing laser beam, and many possible geometric variations of the writing scheme. In an additional embodiment, systems 10 and 40 may use optically sensitive crystals employing optical effects other than phase change to create the diffraction grating to replay the hologram. In a further embodiment, systems 10 and 40 may use a very fine-pixeled SLM to create the intensity pattern, thereby obviating any need to write the intensity pattern to an optically active crystal for replaying the hologram.

As described above, systems 10 and 40 may be used to compare complex images obtained from the same object or target after a physical change occurs to the target or to compare complex images from different targets. In addition, systems 10 and 40 may be used to acquire an image from different locations on target 20. The images at the different locations may have similar features. For example, target 20 may be a semiconductor wafer that includes multiple instances of a single die. In this example, systems 10 and 40 may be used to obtain complex images of a specific area on each of the die. Although the acquired images may have similar features, isoplanatic aberration values (e.g., the first order aberration term focus) associated with each image may be different. This difference may cause virtual, non-existing differences between the images. The aberration value of one of the images, therefore, should be adjusted to ensure that acquired complex images may be accurately compared.

The present invention provides a solution to correcting the aberration values without increasing the time needed to acquire the complex images. Systems 10 and 40 may be used to acquire two complex images from two different locations on target 20. First, the aberration range may be determined such that the aberration difference between the two images has a value between the determined limits. One or more aberration values within the determined aberration range may be selected and an aberration function may be calculated for each of the selected values. Second, the first complex image acquired by systems 10 and/or 40 may be iteratively modified by multiplying each of the aberration values by the first complex image in order to obtain a modified first complex image for each of the calculated aberration values. Third, each of the modified first complex images may be compared with the second complex image. The comparison that yields the smallest variance between the modified first complex image and the second complex image in a high frequency range indicates the best approximation for correcting the aberration difference between the two complex images. In one embodiment, the procedure may be refined by using a finer selection of aberration values around the aberration value determined initially. In another embodiment, the procedure may be refined by using two best approximations for the best aberration value and interpolating a better aberration value between the two best approximations.

In addition to aberration value differences between acquired images, other instrumentation changes may occur in systems 10 and 40 that cause artifacts to occur in the complex images. The artifacts may be small and may occur in the low frequency components of the complex images. In contrast, differences between two similar objects are typically small in size and thus, consist mainly of high frequency spatial components. In standard image processing, any artifacts resulting from changes in an image processing system may be removed in Fourier space. Artifacts resulting from changes in system 10 or 40, however, cannot be removed in Fourier space because each pixel in Fourier space is convoluted with the (complex) spectrum of the variation.

Using the assumptions that the artifacts occur in the low frequency spatial components and any true differences between similar objects occur in the high frequency spatial components, changes in systems 10 and 40 may be approximated by computing the difference between the low frequency components of the complex images (as computed from the holograms). To compensate for the changes, a low pass filter may be applied to the ratio of the complex images. The result may then be used as a multiplicative factor on one of the images, which compensates for the changes of the system.

Mathematical Description of the Invention:

A digital direct to holography system, such as systems 10 and 40, may record several complex images or holograms in the plane of the digital recorder. The recorder plane may be characterized by x- and y-coordinates. From the recorded holograms, the complex image waves of the recorder plane may be computed or reconstructed by applying a Fourier transform to the complex image waves. The Fourier transform of the waves, as reconstructed from the holograms, may contain isoplanatic aberrations, such as the first order aberration term focus. For example, the Fourier transform (FFT) of the image wave ψ(x,y) may be written as

FFT{ψ(x,y)}=FFT{ψ′(x,y)}exp[iχ(qₓ,q_{y})] (1)

where i²=−1,qₓ,q_{y} are the coordinates in the Fourier plane and ψ′(x,y)is the complex image wave at a different aberration value. χ is the aberration function for each of the selected aberration values, and FFT and IFFT respectively represent the forward and inverse Fourier transforms. In order to determine small aberration differences between similar or identical images, at least two images should be compared.

In one embodiment, system 10 and/or 40 may acquire two complex images ψⱼ(x,y) and ψⱼ₊₁(x,y), where j is an integer. A Fourier transform may be applied to both and written such that their actual aberration values can be separated:

FFT{ψⱼ(x,y)}=FFT{ψⱼ′(x,y)}exp[iψⱼ(qₓ,q_{y})] (2)

FFT{ψⱼ₊₁(x,y)}=FFT{ψⱼ₊₁′(x,y)}exp[iχⱼ₊₁(qₓ,q_{y})] (3)

From these equations, the aberration difference between the two images may be described as:

FFT{ψⱼ₊₁(x,y)}/FFT{ψⱼ(x,y)}=exp[iχⱼ₊₁(qₓ,q_{y})]/exp[iχⱼ(qₓ,q_{y})]=exp[i(χⱼ₊₁(qₓ,q_{y})−χⱼ(qₓ,q_{y}))]=exp[iΔχ_{j+1,j}(qₓ,q_{y})]; (4)

where ψⱼ(x,y)≈ψⱼ₊₁(x,y). If image ψⱼ(x,y) does not include similar features to image ψⱼ₊₁(x,y), the aberration function χ(qₓ,q_{y}) may not be directly accessible. However, for similar images, ψⱼ(x,y)≈ψⱼ₊₁(x,y), the above equation is a reasonable approximation. Therefore, if the difference ψⱼ₊₁(qₓ,q_{y})−χⱼ(qₓ,q_{y}) between the images ψⱼ₊₁(x,y) and ψⱼ(x,y) is known, the first complex image may be modified to become:

ψⱼ′=IFFT{FFT(ψⱼ)*exp[iΔχⱼ₊₁(qₓ,q_{y})]} (5)

which is ψⱼ at approximately the same aberration value as ψⱼ₊₁. The step to remove the aberration difference between two similar images, therefore, has been established by modifying image ψⱼ to match the aberration value of image ψⱼ₊₁.

However, the above equation requires that the aberration value between the two complex images be known. In one embodiment, the aberration difference Δψ_{j+1,j} between images ψⱼ(x,y) and ψⱼ₊₁(x,y) may be calculated. If the images ψⱼ(x,y) and ψⱼ₊₁(x,y) are similar, then any detected difference may be smallest if the two images are compared using matching aberration values. This assumption may be important for highly periodic structures because the matching aberration values may occur at several periodic aberration values. In most cases, however, the true aberration value also provides the best match between the images and remains uniquely identifiable.

In the described embodiments, the aberration difference between images ψⱼ(x,y) and ψⱼ₊₁(x,y) may be found within a given range [χₘᵢₙ,χXₘₐₓ]. In one embodiment, the particular aberration may be a first order aberration, such as focus. In this embodiment, the aberration function, without derivation and being valid for high and low angle scattering, may be given by

χ(qₓ,q_{y})=(2Π/λ)Δzsqrt((1−q²λ²)−1) (6)

or using the standard equation for focus

χ(qₓ,q_{y})=(2π/λ)Δz q²λ² (7)

where λ is the wavelength, Δz is the selected focus value from the focus range and q=sqrt(q²ₓ+q²_{y}). In order to determine the actual aberration difference between the complex images, at least two aberration values may be selected from a predetermined range. The aberration function associated with each of the aberration values may then be calculated. Each of these calculated aberration values may then be substituted into the following equation

ψ′¹ⱼ=IFFT{FFT(ψⱼ)exp[iχ¹(qₓ,q_{y})]} (8)

to compute an image modified by the aberration function. Each computed aberration function may be used to compute a modified image and each of the modified images may be compared with the image ψⱼ₊₁(x,y), for example, by computing the variance Δ¹_{j,j+1} of the expression:

Δ¹_{j,j+1}(x¹)=var[mod(ψ′¹j/ψⱼ₊₁)] (9)

Once χ¹o with the smallest Δ¹_{j,j+1} is determined, or by interpolating between the two smallest values, the aberration difference is now known and can be successively eliminated. The two waves to be compared finally are:

ψ′¹ⱼ=IFFT{FFT(ψⱼ)*exp[iχ¹o(qₓ,q_{y})]}; (10)

ψⱼ₊₁(x,y) (11)

Since the aberration value for the two complex images is approximately the same, the images may be accurately compared in a high frequency range to determine if any actual differences exist. By adjusting the aberration value associated with the first complex image, the second complex image does not have to be reacquired, which decreases the amount of time needed to obtain multiple images from target 20.

As described above, artifacts caused by system specific changes may distort the actual differences between the images. These system specific changes that may occur between two complex images typically have a spectrum limited to lower frequencies, and the actual differences between target 20 and the resulting holograms are typically located in the higher frequencies. In general, two complex images ψⱼ(x,y) and ψⱼ₊₁(x,y), as reconstructed from their respective holograms, may be described by:

ψⱼ(x,y)=aⱼexp(iφⱼ) (12)

ψⱼ₊₁(x,y)=aⱼ₊₁exp(iφⱼ₊₁) (13)

The difference between image ψⱼ(x,y) and image ψⱼ₊₁(x,y) may be characterized by the expression

ψⱼ₊₁(x,y)=aⱼ′exp(iφⱼ′)*aₓexp(iφₓ) (14)

where aₓexp(iφₓ) represents the artificial change between the two images caused by the changes in systems 10 and/or 40 and aⱼexp(iφᵢ)˜aⱼ′exp(iφⱼ′)indicating the similarity between the two complex images.

Since the artificial changes are limited to only lower frequencies, a low pass filter may be applied to a ratio of the first and second complex images as follows:

ψₓ(x,y)=IFFT{LPF[FFT(ψⱼ(x,y)/ψⱼ₊₁(x,y))]} (15)

where ψₓ(x,y) is the approximation for the artificial change between two images caused by any changes in systems 10 and/or 40 and LPF describes the low pass filter. In one embodiment, low pass filter may be a Butterworth filter. In other embodiments, low pass filter may be any suitable type of low pass filter that transmits the low frequency components associated with the acquired images. Inserting ψⱼ(x,y) and ψⱼ₊₁(x,y) in the above equation provides the following result:

ψₓ(x,y)=IFFT{FFT{[aⱼexp(iφⱼ)]/[aⱼ₊₁exp(iφⱼ₊₁)]}*LPF}

ψₓ(x,y)=IFFT{[(aⱼ/aⱼ₊₁)exp[i(φⱼ¹−φⱼ₊₁¹)(φⱼ^{h}−φⱼ₊₁^{h})]]*LPF} (16)

where LPF=1 for low frequency components, LPF=0 for high frequency components, φⱼ¹ and φⱼ₊₁¹ respectively represent the low frequency components of image ψⱼ(x,y) and image ψⱼ₊₁(x,y) and φⱼ^{h} and φⱼ₊₁^{h} respectively represent the high frequency components of image ψⱼ(x,y) and image ψⱼ₊₁(x,y). The low pass filter, therefore, eliminates the high frequency components associated with the ratio of the images such that a low frequency ration is obtained. The result of the low pass filter is as follows:

ψₓ(x,y)=(aⱼ/aⱼ₊₁)exp[i(φⱼ¹−φⱼ₊₁¹)] (17)

where ψₓ(x,y) represents the artificial changes present in systems 10 and/or 40. This result may then be multiplied by image ψⱼ₊₁(x,y) to obtain the following modified image:

ψⱼ₊₁′(x,y)=ψⱼ₊₁(x,y)*ψₓ(x,y)

ψⱼ₊₁′(x,y)=aⱼ₊₁exp[i(φⱼ₊₁^{h}+φⱼ₊₁¹)]*(aⱼ/aⱼ₊₁)exp[i(φⱼ¹−φⱼ₊₁¹)]

ψⱼ₊₁′(x,y)=aⱼexp[i(φⱼ₊₁^{h}+φⱼ¹)] (18)

The modified image includes the high frequency components of image ψⱼ₊₁(x,y) and the low frequency components of image ψⱼ(x,y) such that when the modified image is compared with image ψⱼ(x,y) only the high frequency components of each image remain as follows:

ψⱼ(x,y)=ψⱼ₊₁′(x,y)

aⱼexp[i(φⱼ¹+φⱼ^{h})]=aⱼexp[i(φⱼ^{h}+φⱼ¹)]

Δψ_{j,j+1}=exp[i(φⱼ^{h}−φⱼ₊₁^{h})] (19)

where Δψ_{j,j+1}(x,y) represents any actual differences between images ψⱼ(x,y) and ψⱼ₊₁(x,y). Thus, the artificial changes created by systems 10 and/or 40 in the low frequency components of each image may be eliminated such that the actual differences between the two complex images may be determined by comparing the high frequency components of each image.

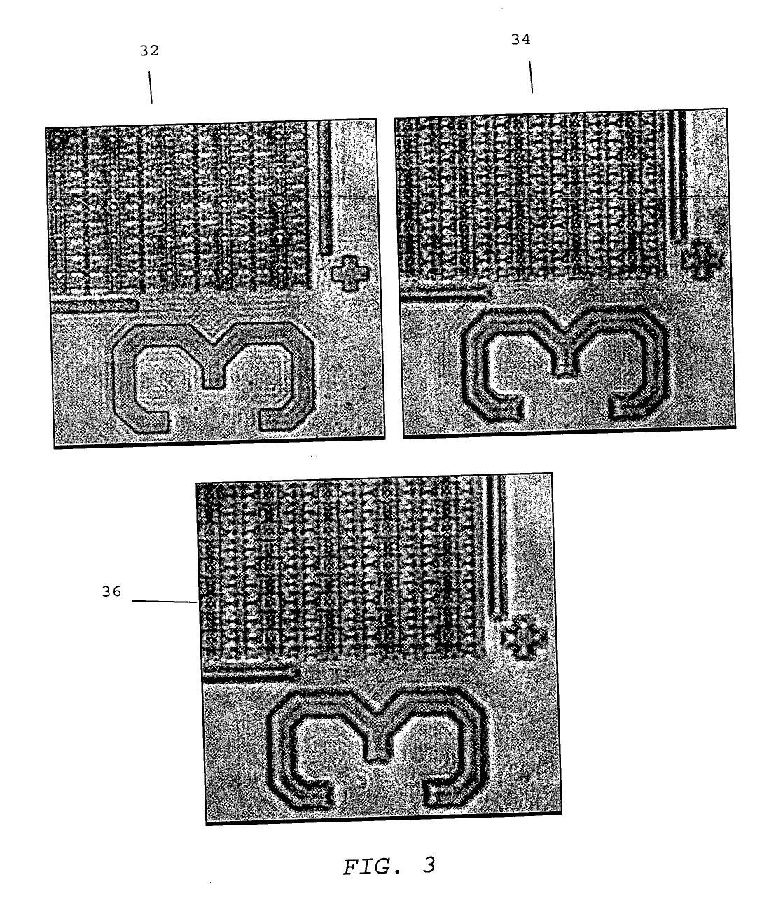

FIG. 3 illustrates multiple complex images acquired by systems 10 and/or 40. Specifically, image 32 is a complex image from one location on target 20 at a first focus value and image 34 is a complex image from another location on target 20 at a second focus value. Image 36 is the complex image represented in image 32 after computing and applying the focus difference between the two complex images. The aperture value used to obtain the images was approximately 0.5 nA and the focus correction is valid for high scattering angles

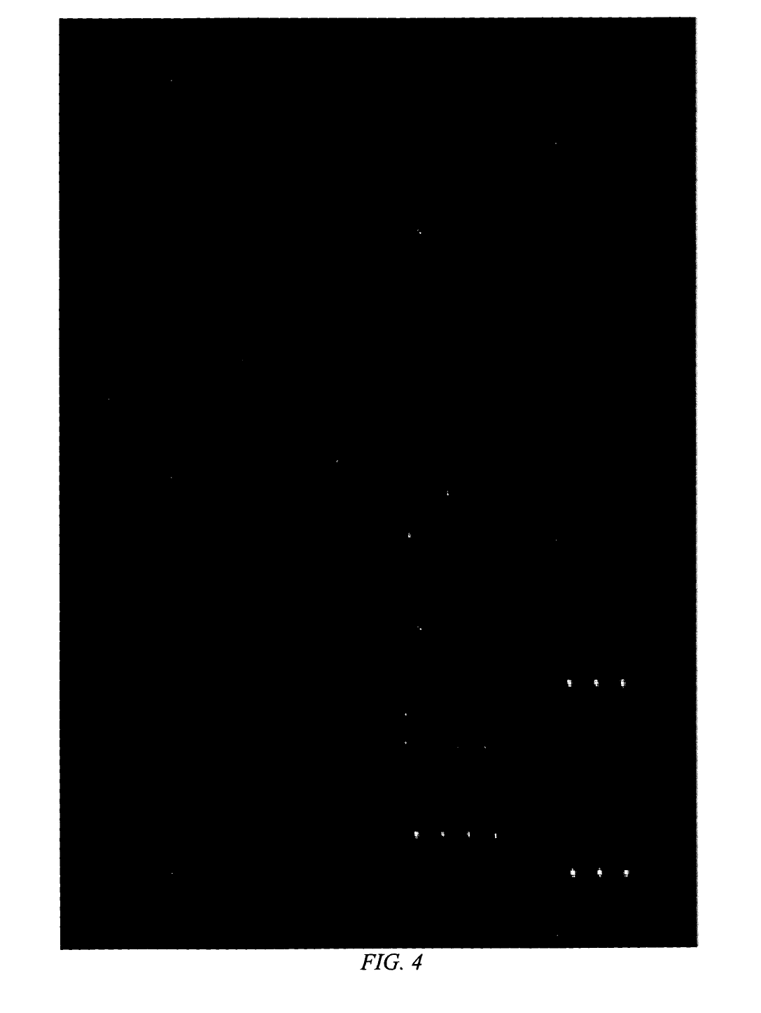

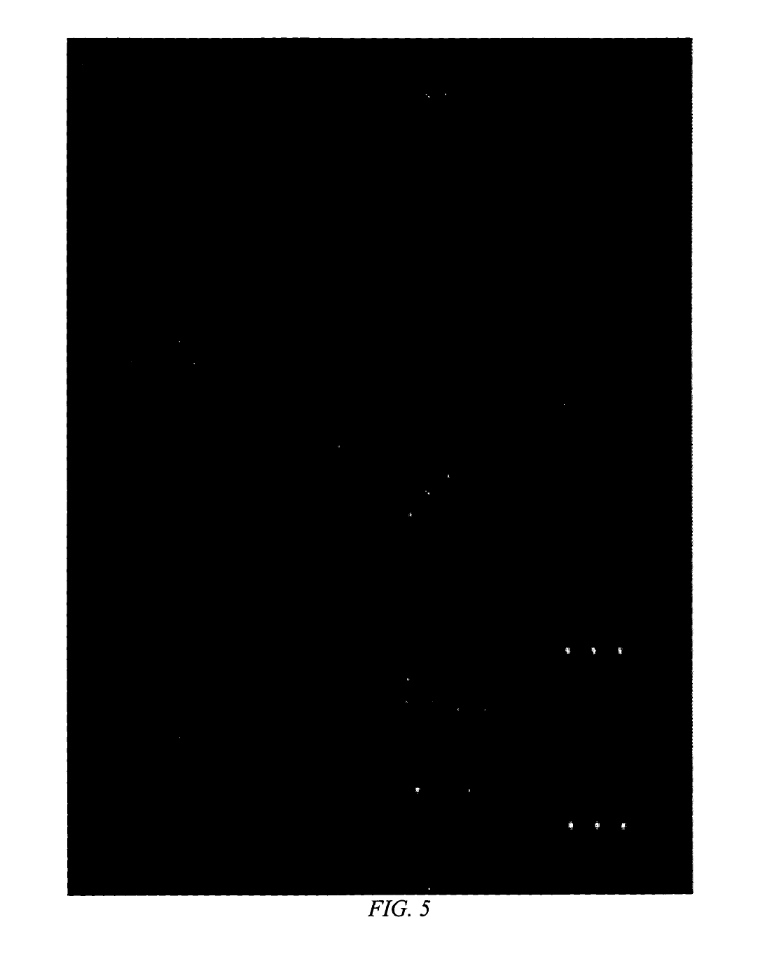

FIGS. 4 and 5 illustrate differences between two complex image acquired by systems 10 and/or 40. Specifically, FIG. 4 illustrates a difference between two complex images without compensating for artifacts caused by system changes. As shown, the image includes multiple artifacts that distort the image. FIG. 5 illustrates the difference image as shown in FIG. 4 after application of the low pass filter (described in detail above) to the ratio of the two acquired images. As shown, the artifacts introduced by small changes in systems 10 and/or 40 may be greatly reduced. In the illustrated embodiment, the bright white spots are defects and the defects that were not detectable in the image shown in FIG. 4, may now be accurately represented since all of the low frequency components associated have been eliminated by the application of the low pass filter.

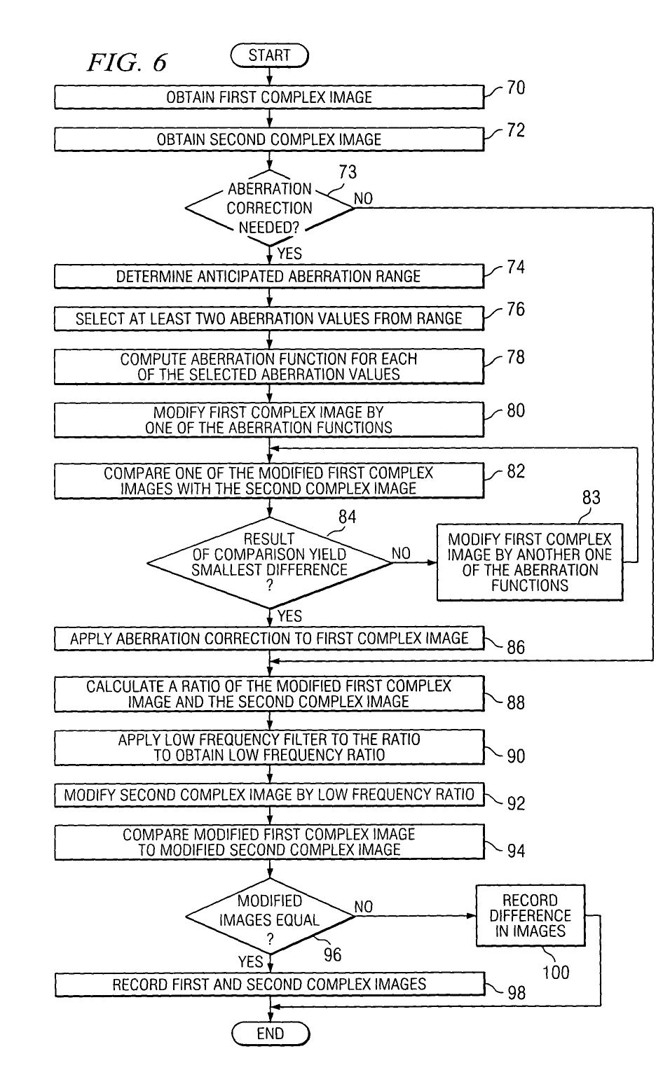

FIGS. 6a and 6b illustrate a flow chart of a method for detecting differences between complex images. Generally, a direct-to-digital holography system may be used to acquire complex images that represent an object or target and determine if the acquired images have any actual differences. During an image acquisition process, changes in the holography system may occur that affect the accuracy of the acquired image. For example, if the holography system obtains similar images from two different locations on an object, each acquired image may include a unique aberration value. The difference in aberration values may cause the holography system to determine that the acquired images are different, when the acquired images actually include the same features. In order to accurately acquire the image without affecting the speed of the image acquisition process, the first image acquired may be iteratively adjusted such that the first acquired image has the aberration value of the second acquired image. The modified first image may then be used to determine if the two acquired images have similar features. Other changes in the holography system may be approximated by computing the difference between the low frequency components for each image. In order to remove the low frequency components of the images, a low pass filter may be applied to a ratio of the images and the result may be used to modify one of the images to compensate for the changes of the holography system. Any differences in the images may then be detected in the high frequency components.

At step 70, system 10 or 40 may acquire a first complex image from target 20. In one embodiment, target 20 may be an electronic device fabricated from silicon, germanium, or any compound including a group III and/or group IV elements. In another embodiment, target 20 may be a photomask or reticle including a pattern formed on a substrate. In other embodiments, target 20 may be any object, component or assembly that may be analyzed by systems 10 and 40 in order to verify shapes and dimensions. At step 72, a second complex image may be acquired from target 20. The second complex image may be acquired from the same object to calculate a physical change in the object or the second complex image may be acquired from a like object to measure deviations of the second object from the first object. At step 73, system 10 and/or 40 determined if an aberration correction is needed to match the first and second images. If the aberration value for the second image is different than the aberration value for the first image, an anticipated aberration range may be determined at step 74. The anticipated range may be based on previously determined values associated with a specific object or estimations based on the type (e.g., a semiconductor wafer, a photomask, etc.) of object. In order to converge on the actual aberration difference between the first and second images, at least two aberration values may be selected from the range at step 76. In one embodiment, two best values may be selected and an estimated aberration difference may be interpolated by using the two best values. In another embodiment, multiple values may be selected. At step 78, each of the selected aberration values may be used to calculate an aberration function. In one embodiment, the aberration function may be used to calculate a first order aberration value such as focus.

At step 80, the calculated aberration function may be used to iteratively modify the first complex image. In one embodiment, a Fourier transform may be applied to the first complex image and this result may be multiplied by the aberration function. This process may be repeated for each of the calculated aberration functions such that the first complex image may be modified multiple times. An inverse Fourier transform may be performed on the modified first complex image after each of the aberration functions is applied in order to convert the modified first complex image back to the time domain. The modified first complex image associated with each of the aberration functions may then be compared with the second complex image to determine an aberration correction at step 82. In one embodiment, the images may be compared by computing the variance of the modulus of the ratio of the modified first complex image and the second complex image.

At step 84, the difference between the high frequency components of the modified first complex image and the second complex image may be analyzed. If the difference is the smallest variance between the images, the aberration value used to calculate the particular aberration function is selected as the best approximation of the aberration correction at step 86. Otherwise, the first complex image is modified first complex associated with another aberration value at step 83 and the new modified complex image is compared with the second complex image at step 82. Once the smallest variance between the two images is determined using the iterative process, the aberration value associated with the smallest variance is applied to the first complex image in order to obtain the modified first complex image at step 86.

After obtaining an appropriate aberration correction value, the ratio of the modified first complex image and the second complex image may be calculated at step 88. In one embodiment, the aberration values between the first and second complex images may be similar such that no adjustment to the first complex image is needed. In this embodiment, the modified first complex image may be approximately equal to the first complex image. The two acquired complex images may contain artifacts caused by changes in systems 10 and/or 40. These artifacts may exist in the low frequency components associated with the images while any actual differences may exist in the high frequency components. In order to effectively remove the low frequency components from the comparison of the modified first complex image and the second complex image, a low pass filter may be applied to the ratio at step 90. In one embodiment, a Fourier transform may be applied to the ratio such that the ratio of the images is converted to the frequency domain and the low pass filter may be applied in the frequency domain. An inverse Fourier transform may then be applied to convert the low frequency ratio back to the time domain.

At step 92, the low frequency ratio may be multiplied by the second complex image to obtain a modified second complex image. By applying the low frequency ratio to the second complex image, the low frequency components of the second complex image are replaced with the low frequency components of the first image. The modified second complex image may then be compared to the modified first complex image at step 94. In this comparison, only the high frequency components associated with each of the first and second complex images are compared in order to determine any actual differences between the images. The system determines if the high frequency components of the two images are approximately the same at step 96. If there is no difference between the modified first complex image and the modified second complex image, systems 10 and/or 40 determine that the images are similar at step 98. If a difference is determined, the difference may be recorded at step 100. In one embodiment, target 20 may be a semiconductor wafer and the calculated difference between images may indicate a defect at a particular location on the wafer.

Although the present invention has been described with respect to a specific preferred embodiment thereof, various changes and modifications may be suggested to one skilled in the art and it is intended that the present invention encompass such changes and modifications fall within the scope of the appended claims.

What is claimed is:

1. A method for detecting differences between complex images, comprising:
acquiring a first complex image and a second complex image;
applying a low pass filter to a ratio of the first and second complex images to obtain a low frequency ratio;
modifying the second complex image by the low frequency ratio to replace low frequency components of the second complex image with low frequency components of the first complex image; and
comparing the modified complex image to the first complex image to determine if the second complex image matches the first complex image.

2. The method of claim 1, further comprising calculating a Fourier transform of the ratio of the first and second complex images in order to apply the low pass filter in a frequency domain.

3. The method of claim 2, further comprising calculating an inverse Fourier transform of the low frequency ratio in order to modify the second complex image in a time domain.

4. The method of claim 1, wherein comparing the modified complex image to the first complex image comprises comparing high frequency components of the first and second complex images.

5. The method of claim 1, wherein the first and second complex images comprise holographic images.

6. The method of claim 1, further comprising the low frequency components associated with the second complex image representing system changes in an image acquisition system.

7. A method for detecting differences between complex images, comprising:
acquiring a first complex image and a second complex image;
calculating a Fourier transform of a ratio of the first and second complex images to obtain a frequency domain ratio;
applying a low pass filter to the frequency domain ratio to obtain a low frequency ratio;
calculating an inverse Fourier transform of the low frequency ratio to convert the low frequency ratio into a time domain;
modifying the second complex image by the transformed low frequency ratio to replace low frequency components of the second complex image with low frequency components of the first complex image; and
comparing the modified complex image to the first complex image to determine if the second complex image matches the first complex image.

8. The method of claim 7, wherein comparing the modified complex image to the first complex image comprises comparing high frequency components of the first and second complex images.

9. The method of claim 7, wherein the first and second complex images comprise holographic images.

10. The method of claim 7, further comprising the transformed low frequency ratio operable to reduce artificial changes in the first and second complex images generated by an image acquisition system.

11. A system for detecting differences between complex images, comprising:
a digital recorder operable to acquire a first complex image and a second complex image; and
processing resources coupled to the digital recorder, the processing resources operable to:
apply a low pass filter to a ratio of the first and second complex images to obtain a low frequency ratio;
modify the second complex image by the low frequency ratio to replace low frequency components of the second complex image with low frequency components of the first complex image; and
compare the modified complex image to the first complex image to determine if the second complex image matches the first complex image.

12. The system of claim 11, further comprising the processing resources operable to calculate a Fourier transform of the ratio of the first and second complex images in order to apply the low pass filter in a frequency domain.

13. The system of claim 12, further comprising the processing resources operable to calculate an inverse Fourier transform of the low frequency ratio in order to modify the second complex image in a time domain.

14. The system of claim 11, wherein comparing the modified complex image to the first complex image comprises comparing high frequency components of the first and second complex images.

15. The system of claim 11, wherein the first and second complex images comprise holographic images.

16. The system of claim 11, wherein the digital recorder comprises a CCD camera.

17. The system of claim 11, further comprising a beam combiner optically coupled to the digital recorder, the beam combiner operable to receive a reference beam and an object beam to generate the first and second complex images.

18. A method for detecting differences between complex images, comprising:
acquiring a first complex image and a second complex image, the first and second complex images including similar features;
selecting a plurality of aberration values for the first complex image from an anticipated aberration range;
computing an aberration function for each of the selected aberration values;
iteratively modifying the first complex image by each of the aberration functions;
comparing the modified complex image with the second complex image; and
determining an aberration correction value by selecting the aberration value that yields the smallest difference between the modified complex image and the second complex image.

19. The method of claim 18, further comprising performing a Fourier transform on the first complex image such that the first complex image is modified in a frequency domain.

20. The method of claim 19, further comprising performing an inverse Fourier transform on the modified complex image before comparing the modified complex image with the second complex image.

21. The method of claim 18, wherein comparing the modified complex image with the second complex image comprises determining a variance of a modulus of a ratio of the modified complex image and the second complex image.

22. The method of claim 21, wherein determining the aberration correction value comprises selecting the ratio having the smallest variance between the modified complex image and the second complex image.

23. The method of claim 18, wherein the first and second complex images comprise holographic images.

24. The method of claim 18, wherein the anticipated aberration range includes a minimum aberration value and a maximum aberration value.

25. The method of claim 18, wherein the aberration value comprises a focus value.

26. A method for detecting differences between complex images, comprising:
acquiring a first complex image and a second complex image, the first and second complex images including similar features;
selecting a plurality of aberration values for the first complex image from an anticipated aberration range;
computing an aberration function for each of the selected aberration values;
performing a Fourier transform on the first complex image to obtain a transformed complex image;
iteratively modifying the transformed complex image by each of the aberration functions;
performing an inverse Fourier transform on the modified complex image to convert the low frequency ration into a time domain;
comparing high frequency components of the transformed complex image with high frequency components of the second complex image; and
determining an aberration correction value by selecting the aberration value that yields the smallest difference between the transformed complex image and the second complex image.

27. The method of claim 26, wherein comparing the transformed complex image with the second complex image comprises determining a variance of a modulus of a ratio of the transformed complex image and the second complex image.

28. The method of claim 27, wherein determining the aberration correction value comprises selecting the ratio having the smallest variance between the transformed complex image and the second complex image.

29. The method of claim 26, wherein the first and second complex images comprise holographic images.

30. A system for detecting differences between complex images, comprising:
a digital recorder operable to acquire a first complex image and a second complex image, the first and second complex images including similar features; and
processing resources coupled to the digital recorder, the processing resources operable to:
select a plurality of aberration values for the first complex image from an anticipated aberration range;
compute an aberration function for each of the aberration values;
iteratively modify the first complex image by each of the aberration functions;
compare the modified complex image with the second complex image; and
determine an aberration correction value by selecting the aberration value that yields the smallest difference between the modified complex images and the second complex image.

31. The system of claim 30, further comprising the processing resources operable to perform a Fourier transform on the first complex image such that the first complex image is modified in a frequency domain.

32. The system of claim 31, further comprising the processing resources operable to perform an inverse Fourier transform on the modified complex image before comparing the modified complex image with the second complex image.

33. The system of claim 30, wherein comparing the modified complex image with the second complex image comprises determining a variance of a modulus of a ratio of the modified complex image and the second complex image.

34. The system of claim 33, wherein determining the aberration correction value comprises selecting the ratio having the smallest variance between the modified complex image and the second complex image.

35. The system of claim 30, wherein the first and second complex images comprise holographic images.

36. The system of claim 30, wherein the digital recorder comprises a CCD camera.

37. The system of claim 30, further comprising a beam combiner optically coupled to the digital recorder, the beam combiner operable to receive a reference beam and an object beam to generate the first and second complex images.

38. A method for detecting differences between complex images, comprising:
acquiring a first complex image and a second complex image, the first and second complex images including similar features;
determining if an aberration value difference exists between the first and second complex images;
correcting the aberration value difference by iteratively modifying the first complex image by an aberration function and comparing the modified first complex image with the second complex image in a high frequency range;
modifying the second complex image with a low frequency ratio to replace low frequency components of the second complex image with low frequency components of the first complex image; and
comparing high frequency components of the modified first complex image and the modified second complex images to determine if the first complex image matches the second complex image.

39. The method of claim 38, further comprising:
selecting a plurality of aberration values for the first complex image from an anticipated aberration range; and
computing the aberration function for each of the aberration values.

40. The method of claim 38, further comprising performing a Fourier transform on the first complex image such that the first complex image is modified in a frequency domain.

41. The method of claim 40, further comprising performing an inverse Fourier transform on the modified first complex image before comparing the modified first complex image with the second complex image.

42. The method of claim 38, wherein comparing the modified first complex image with the second complex image comprises determining a variance of a modulus of a ratio of the modified first complex image and the second complex image.

43. The method of claim 42, further comprising determining an aberration correction value by selecting the ratio having the smallest variance between the modified first complex image and the second complex image.

44. The method of claim 38, further comprising applying a low pass filter to a ratio of the modified first complex image and the second complex image to obtain the low frequency ratio.

45. The method of claim 44, further comprising calculating a Fourier transform of the ratio of the modified first complex image and the second complex image in order to apply the low pass filter in a frequency domain.

46. The method of claim 45, further comprising calculating an inverse Fourier transform of the low frequency ratio in order to modify the second complex image in a time domain.

47. The method of claim 38, wherein the first and second complex images comprise holographic images.
